(19) United States
(12) Patent Application Publication
(10) Pub. No.: US 2008/0251599 A1
(43) Pub. Date: Oct. 16, 2008

(54) Vapor Emitting Device

(76) Inventors: Bennett C. Ward, Midlothian, VA (US); Jian Xiang, Midlothian, VA (US); Yelena N. Rogova, Richmond, VA (US)

Correspondence Address: J. Michael Martinez de Andino, Esq.;HUNTON & WILLIAMS LLP, Riverfront Plaza, East Tower, 951 E. Byrd Street, Richmond, VA, 23219-4047, US

(21) Appl. No.: 12/099,942

(22) Filed: Apr. 9, 2008

Related U.S. Application Data
(60) Provisional application No. 60/911,093, filed on Apr. 11, 2007.

(51) Int. Cl. B65D 83/00; B67D 5/08

(52) U.S. Cl. 239/44; 222/187; 222/23

(57) ABSTRACT

The invention is generally directed to a vapor emitting device having a container, at least one liquid in the container, and a wick. The container has an interior in which the at least one liquid is disposed. The wick has a distal portion disposed in the container interior and a proximal portion. The wick is configured and positioned so as to maintain contact with the at least one liquid and allows the wick to draw the at least one liquid into and through the distal portion toward the proximal portion, thereby making the at least one liquid available for evaporation when the proximal portion is exposed to air. A change in a visible characteristic of the wick occurs upon exhaustion of the at least one liquid from the wick.

This application claims priority to Provisional Application Ser. No. 60/911,093, filed on Apr. 11, 2007, which is incorporated herein by reference in its entirety.

### BACKGROUND OF THE INVENTION

The invention is directed generally to vapor emitting devices. Specifically, the invention is directed to wicks used to emit vapor, such as fragrances, insect repellants, and the like. The wick will indicate via color change when the liquid to be dispensed is exhausted. In other words, a visible characteristic of the wick will change when the liquid to be dispensed or broadcast is exhausted.

Vapor emitting devices are generally well known in the art. For example, known air freshener systems typically may comprise a container that holds a fragrance dissolved in a volatile liquid carrier. A porous wick may be inserted into this liquid and the wick may transport the liquid through the top of the container and provide an evaporation surface to allow the fragrance to be broadcast into the air.

The container of such systems is often transparent and constructed from materials such as glass or transparent plastic. The transparency of the material allows the user to determine when the container is empty and requires a replacement. However, transparent containers may present issues to consumers. For example, if the container is made of glass the containers may break. If the containers are made of transparent plastic solvents that may be present in the liquid to be dispensed may interact with the plastic and may cause clouding, crazing or failure. Moreover, transparent containers may be placed in certain low light or odd-angle situations where it may be difficult to see if the fragrance solution has been exhausted. Additionally, overall design considerations may mitigate against use of a transparent container or device.

Moreover, use of color change to inform a user when a device has been activated has been reported in U.S. patent application Ser. No. 10/495,714, which provides for a color change to occur in a wick informing a user that a diagnostic device has been charged with analyte—containing liquid.

Accordingly, there is a need for a vapor emitting device that does not require a transparent container and that clearly indicates via a color change or change in a visual characteristic when the liquid to be broadcast is exhausted, and the container needs to be replaced.

### SUMMARY OF THE INVENTION

Aspects of the invention include a vapor emitting device having a container, at least one liquid in the container, and a wick. The container has an interior in which the at least one liquid is disposed. The wick has a distal portion disposed in the container interior and a proximal portion. The wick is configured and positioned so as to maintain contact with the at least one liquid and allows the wick to draw the at least one liquid into and through the distal portion toward the proximal portion, thereby making the at least one liquid available for evaporation when the proximal portion is exposed to air. A change in a visible characteristic of the wick occurs upon exhaustion of the at least one liquid from the wick.

It is to be understood that both the foregoing general description and the following detailed description are exemplary and explanatory only, and are not restrictive of the invention as claimed. The accompanying drawings constitute a part of the specification, illustrate certain embodiments of the invention and, together with the detailed description, serve to explain the principles of the invention.

### BRIEF DESCRIPTION OF THE DRAWINGS

FIG. 1 depicts a vapor emitting device, in accordance with some embodiments of the present invention.

FIGS. 2A-2D depict a vapor emitting device at various time intervals, in accordance with some embodiments of the present invention.

FIGS. 3A-3D depict a vapor emitting device at various time intervals, in accordance with some embodiments of the present invention.

### DETAILED DESCRIPTION OF THE INVENTION

Throughout the specification, the term “fragrance” or “fragrances” is used generically to indicate the use of an active agent or like item in a liquid. Similarly, the term “liquid” or “liquids” refers to a substance whose molecules move freely past one another including, but not limited to, a liquid. The term “liquids” may be single or multi-phase, and may include particulate matter suspended in the liquid.

Reference will now be made in detail to the invention, examples of which are illustrated in the accompanying drawings. While the discussion below is directed, for clarity, to an air freshener system, it is fully contemplated that such systems may be used for insecticide emitters, insect repellant emitters, humidifiers, odor removal compounds, and other functional liquid-to-vapor distribution devices. In general, the present invention is directed to vapor emitting devices with an end-of-life indicator. The present invention discloses two (2) general types of vapor emitting devices with end-of-life indicators: (i) a dual phase vapor emitting system and (ii) a single phase vapor emitting system. Each system will be addressed in turn below.

In accordance with the present invention, both types of vapor emitting devices may comprise a wick. The wick may be made from any material with a sufficient surface energy to wet out and wick fluids. Such materials may include open cell foam, sintered plastic, fibrous materials, cloth, paper, biological materials such as hemp, etc. In accordance with some embodiments of the present invention, the wick may be comprised of fibers. The fibers may be in the form of bundled individual filaments, tows, roving or lightly bonded non-woven webs or sheets. The fibers may be mechanically crimped or may be structured so that self-crimping may be induced (e.g., by stretching and then relaxing the fibers) during the continuous forming process. The fibers may be formed from various methods, including melt blown or formed by a spun bond process.

Moreover, particular fiber types may be selected based upon the desired characteristics of the final product. Fiber qualities which may be varied include: the overall fiber material for mono-component fibers, the fiber core and sheath material for bicomponent fibers, the fiber diameter, the fiber length, the fiber orientation, finishes on the fiber (e.g. hydrophilic, hydrophobic), the crimp level of the fiber, or any particulate loading of the fibers.

While the fibers may be used in any format, it is anticipated that the fibers may be used to form a self-sustaining, three dimensional, bonded fiber structure. The selection of fibers and fiber characteristics for such self-sustaining, three dimensional, bonded fiber structure may impact the manufacturing process. For example, if staple fibers are used, the first stage of the manufacturing is generally opening, or isotropically distributing, the staple. Following opening, the fibers are distributed into a web. The web production may occur in at least two ways: carding or air-laying. Carding fibers is combing the fibers so that the fibers generally lay in the same orientation. Air-laying fibers generally results in the fibers having an entirely isotropic (or random) orientation. If the fibers are carded, the desired length is generally between 20 mm and 50 mm. However, if the fibers are air-laid, the desired length is generally between 4 mm to 30 mm. In a filament or continuous fiber process, the fibers are not cut into staple fibers, but may be used in a continuous fashion, utilizing either creeled filaments, filament processed into crimped tows, or as continuous melt-blown or spun-bond webs.

Once the staple fibers are arranged, they may undergo another process to form a sustainable web. Forming of the web may occur through a variety of processes. The fibers may be heated, such that initial point-to-point bonding occurs enough to sustain a web. The fibers may be passed through a through-air bonding oven to form a substantially self-sustaining web. Instead, the fibers may also undergo needle-punching, where multiple needles push through the fibers, causing the fibers to be tangled in such a manner as to cause a sustainable web. The fibers may also be hydro-entangled. The sustainable webs may then be rolled up or otherwise gathered and prepared for the next process.

Three dimensional bonded fiber structures may be made by several manufacturing processes. An example of a process that can be used to make the composite structures of the invention is a pneumatic forming process, such as that disclosed in U.S. Pat. Nos. 3,533,416, 3,599,646, 3,637,447, and 3,703,429, each of which is incorporated herein by reference in its entirety. The process utilizes tows of fibers (such as cellulose acetate or nylon), which, when treated with a plasticizer, may be impinged in a forming die with air pressure and then treated with steam to form a porous, 3 dimensional, self sustaining, bonded fiber structure. The process can be modified to produce the composite structures of the invention by using a forming die having a plurality of zones. Using this die, tows with different fiber sizes, cross sections or feed rates can be used to form composite materials.

Moreover, the wick may be comprised of different components. For example, the wick may comprise unbonded fibers held together by a wrap. Another example may be the use of different components, such as a fibrous component and a non-fibrous component (e.g., plastic, etc.). Such components may be assembled into a single wick, or may be integrally formed. Alternatively, the wick may comprise different fibrous components, each made from fibers with different characteristics or types. Moreover, the multicomponent wick may have the same fiber material in different components, but in a different form. For example, one component may have long, hot air bonded staple fibers, while another component may have continuous fibers or short, air-laid staple fibers of the same material. The different components may also have differences as simple as porosity differences (for example, a highly porous, low density layer and a low porosity, high density layer). In this case, the layer with the small pores will have a higher capillary strength that that with the larger pores. Multicomponent structures made from different fibrous components may be formed using continuous processing methods similar to those used to produce isotropic fibrous structures.

A. Two-Phase System

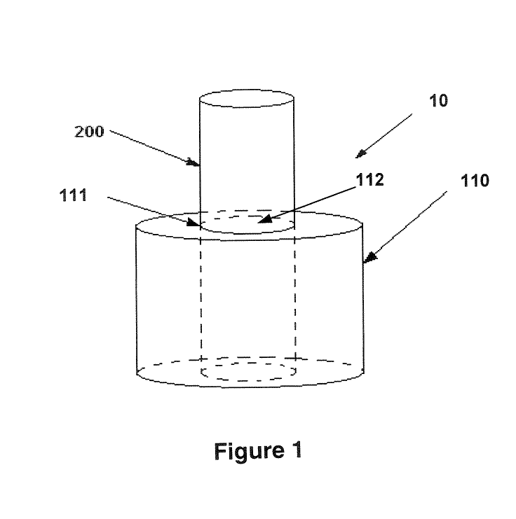

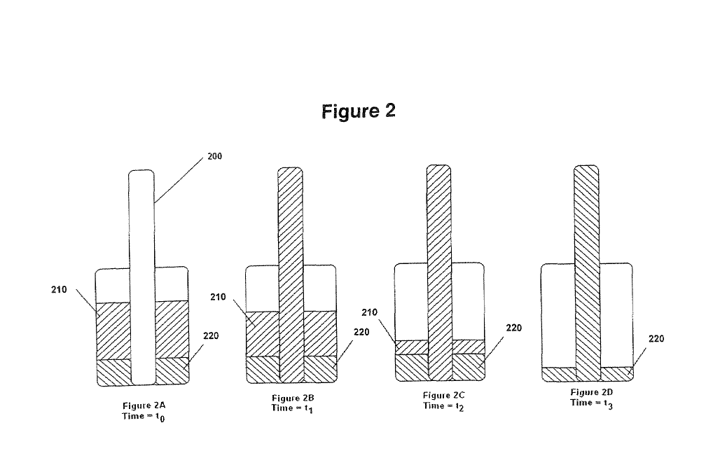

With reference to FIG. 1, a vapor emitting device 10 in accordance with some embodiments of the present invention will now be discussed. In general, the vapor emitting device comprises a container 110 with a cap 111 having an opening 112, and a wick 200. With reference to FIGS. 1 and 2, a two phase (or layer) liquid system with one phase resting on top of, and being immiscible (or essentially immiscible) in the lower liquid phase may be disposed in the container 110. In the two phase system, the wick 200 may comprise a distal portion that is disposed within the container interior and a proximal portion. The wick 200 may be configured so that it maintains contact with the liquid or liquids in the container. The wick 200 draws the liquid or liquids into and through the distal portion towards the proximal portion, thereby making the liquid or liquids available for evaporation when the proximal portion is exposed to air. A change in a visible characteristic of the wick 200 occurs upon exhaustion of the first phase.

The two phase liquid system depicted in FIGS. 1 and 2 may comprise a organic phase 210 and an aqueous phase 220. The organic phase 210 may be primarily comprised of a volatile, organic, lower specific gravity, water immiscible solvent containing a dissolved fragrance component. The aqueous phase 220 may be comprised primarily of water, with a higher specific gravity, colored by a dyestuff, which is immiscible with the organic phase 210.

The wick 200 may comprise a distal portion that is disposed within the container interior and a proximal portion. The wick 200 may penetrate both the organic 210 phase and the aqueous 220 phase and may penetrate the cap 111 of the container 110 via the opening 112, thereby allowing a portion of the wick 200 to be exposed to the ambient environment where the organic phase 210 including the fragrance is to be broadcast. The wick 200 may become saturated with the organic phase 210, and may transport via capillary action the organic phase 210 to the portion of the wick 200 outside the container 110. The volatile nature of the organic phase 210 may allow the organic phase 210 (including the fragrance) to be evaporated into the ambient space surrounding the exposed portion of the wick 200.

The wick 200 may be designed to have the correct balance of organic solvent attraction and aqueous attraction so that the organic phase 210 will be wicked out of the container 110 to the approximate exclusion of the organic phase 220—even if the container is shaken or inverted—so that only when the organic phase 210 is essentially exhausted will the aqueous phase 220, colored by the dyestuff, travel up the wick 200. As the aqueous phase 220 including the dyestuff is drawn into the wick 200, the wick 200 may be colored with the dyestuff. The wick 200—including the portion outside the container—may therefore turn the color of the dyestuff, thus indicating to the observer that the fragrance-containing portion (the organic phase 210) is exhausted and that the container needs to be replaced.

The vapor emitting device 10 may therefore utilize the immiscibility of the two phases and provide an indication when the organic phase 210 is substantially exhausted. A primary component of the vapor emitting device 10 is the wick 200. The wick 200 may be designed in such a way that the wick 200 absorbs and wicks substantially all of the organic phase 210 first, and then, because of the wick's sufficient hydrophilicity, wick the aqueous phase 220 containing the dyestuff.

With continued reference to FIGS. 1 and 2, at time t0 the wick 200 has just been inserted into a liquid mixture comprising an organic phase 210 and an aqueous phase 220. The aqueous phase 220 comprises a colored dyestuff, and is colored by the dyestuff. At time t0, the wick 200 has not yet wicked either phase. At time t1, the wick 200 is saturated with the first phase 210, and transports the organic phase 210 to the exposed portion of the wick 200 where the organic phase 210 may be evaporated into the ambient surroundings. At time t2, the wick 200 is still wicking and distributing the organic phase 210, thereby reducing the available amount of the organic phase 210 in the container 110, while the volume of the aqueous phase 220 has not changed. At time t3, the organic phase 210 has been exhausted, and the wick 200 is now saturated by the aqueous phase 220. As the aqueous phase 220 is drawn into the wick 200, the wick 200 may turn the color of the dyestuff contained in the aqueous phase 220, thereby indicating that the organic phase 210 is exhausted and the container has reached the end of its effective life.

The two phase system for the vapor emitting device may function in one of several ways described below. The wick 200 may (1) first become saturated with the organic phase 210 and not allow the aqueous phase 220 to wick above its own level in the container, even if the liquids are agitated, then (2) allow the organic phase 210 to wick to the top and be evaporated from the exposed portion of the wick, and then (3) only when the organic phase 210 is approximately exhausted does the colored aqueous phase 220 travel to the top of the wick, with the dye in the aqueous phase 220 coloring the wick 200.

In accordance with some embodiments of the present invention, the wick 200 may also (1) first become saturated with the aqueous phase 220 and not allow the colored organic phase 210 to wick above its own level in the container, even if the liquids are agitated, then (2) allow the aqueous phase 220 to wick to the top and be evaporated from the exposed portion of the wick, and then (3) only when the aqueous phase 220 is approximately exhausted does the colored organic phase 210 travel to the top of the wick, with the dye in the organic phase 210 coloring the wick 200.

The vapor emitting device 10 may be used as an air freshener, insecticide emitter, insect repellant emitter, humidifier wick, a dispenser for odor removal compounds, and other functional liquid-to-vapor devices to visually indicate an end-of-life through a change in wick color. The vapor emitting device 10 does not require external power, and may illustrate the exhaustion of a liquid even after being exposed to the shaking and agitation that may be present during normal transportation.

In order for a wick to successfully operate in the two-phase system, the wick must initially wick one phase to the exclusion of the other, and only upon exhaustion of the first phase may the wick draw the second phase. In accordance with some embodiments of the invention, the wick may initially wick the organic phase 210 to the exclusion of the aqueous phase 220, and only upon exhaustion of the organic phase 210, draw the aqueous phase into the wick. Furthermore, the wick 200 should maintain this order of wicking, particularly when the vapor emitting device is exposed to prolonged vibration and/or shaking.

In accordance with some embodiments of the present invention, the wick 200 may be made from a plurality of fiber components, either bonded or non-bonded, woven or non-woven, unwrapped or wrapped with a plastic film or non-woven. The wick 200 may be made of a plurality of fiber types including, but not limited to, monocomponent and/or bicomponent fibers. The wick 200 can also be made from a blend of fiber types and materials. As described in U.S. Pat. Nos. 5,607,766, 5,620,641, 5,633,082, 6,103,181, 6,330,883, and 6,840,692, each of which is incorporated herein by reference in its entirety, there are many forms of and uses for bonded fiber components and structures, as well as many methods of manufacture. In general, such bonded fiber components and structures are formed from webs or bundled strands of thermoplastic fibrous material comprising an interconnecting network of highly dispersed continuous fibers bonded to each other at points of contact. These webs can then be formed into substantially self-sustaining, three-dimensional porous components and structures. These components or structures may provide high surface areas and porosity, and may be formed in a variety of sizes and shapes. These components or structures may be adapted to provide wicks with neutral displacement or multi-layer or gradient wick structures, for example as disclosed in U.S. patent application Ser. Nos. 11/765,538 and 11/333,499, which are incorporated herein by reference in their entirety.

In accordance with some embodiments of the present invention, the wick 200 may be comprised of melt blown, bicomponent fibers, where the fibers are sheath/core bicomponent fibers, with the sheath comprised of a mixture of nylon-6 and hydrophilic nylon (which is a block copolymer of nylon-6 and poly(ethylene oxide)), and the core comprised of either a polyolefin, such as polypropylene, a polyester, such as polybutylene terephthalate or polyethylene terephthalate, or a polyamide, such as nylon-6. In accordance with some embodiments of the present invention, these fibers sequentially wick organic material, and then wick aqueous material. In accordance with some embodiments of the present invention, the wick 200 may comprise fiber systems made of alternating mixed fiber construction, where there is a series of sheath/core bicomponent fibers (where the sheath is a blend of nylon-6 and hydrophilic nylon and the core is polyester), alternating with a homofilament of the core resin of its neighbor.

In accordance with some embodiments of the present invention, the wick may be comprised of a blend level of 81%-99% by weight nylon-6, and 19%-1% by weight hydrophilic nylon. In order to achieve the desired blend, and by way of example only, polymer chip was dry blended by weight prior to charging into the polymer extruder, which melted the blended polymer chip for subsequent melt blowing. Other methodologies for forming random or block copolymers, or for creating miscible or immiscible polymer blends may be employed.

It is anticipated that similar fluid treatment properties may be achieved through the use of surface energy altering additives or permanent finishes. In accordance with some embodiments of the present invention, the wick 200 may be comprised of melt blown, bicomponent fibers, where the fibers were sheath/core bicomponent fibers, with the sheath comprised of a polyolefin copolymer and the core comprised of polypropylene, where a hydrophilic additive was added to both the sheath and core. In accordance with some embodiments of the present invention, and as a non-limiting example, the desired fluid treatment properties may be achieved in a sheath/core bicomponent fiber by mixing 3% additive (prior to the extruder) to the sheath and 2%-5% additive to the core polymer. In order to wick the aqueous phase before the organic phase, highly hydrophilic materials may be used. For example, 100% hydrophilic nylon may be used.

B. Single Phase System.

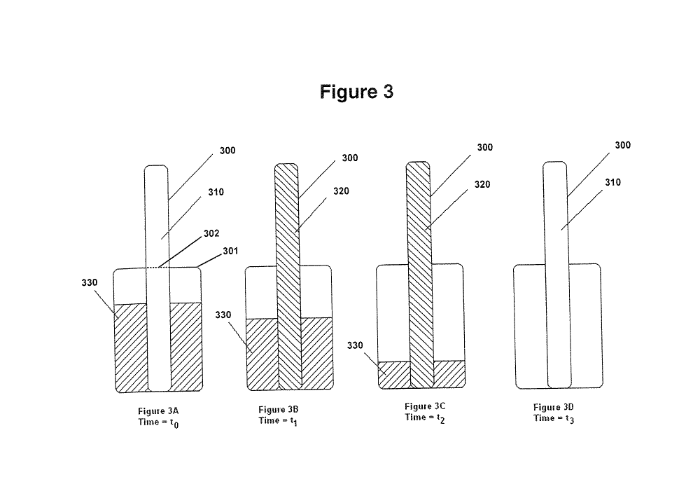

With reference to FIGS. 3A-3D, a single phase vapor emitting device in accordance with some embodiments of the present invention will now be discussed. Similar to the two phase system, the single phase vapor emitting device may comprise a container 301 with a cap 302 to hold a liquid fragrance mixture and a wick 300, the cap 302 having a hole in it; a wick 300 with a proximal portion in the container and a distal portion; and a single phase liquid system 330. The single phase liquid system 330 may be comprised of a mixture of a water-miscible volatile, organic solvent containing a dissolved fragrance component and water containing a volatile acidic or basic additive. The single phase liquid system may therefore have a pH of between 1.5-4.5 (when acidic) or between 8.0-10.5 (when basic). The wick 300 may be immersed in the single phase liquid system 330 and may penetrate the cap 302 of the container 301 to be exposed to the ambient environment where the fragrance is to be broadcast.

The single phase system may operate in at least two (2) distinct manners: (i) pH Sensitive Wick; and (ii) pH Sensitive Dye Visible In Wick.
i. pH Sensitive Wick

In accordance with some embodiments of the invention, the material forming the wick 300 may be sensitive to the concentration of acid or base in the liquid contained therein, such concentration commonly described as pH, and may change color depending on the pH of the fluid contained in the wick. In this manner, the wick may have an initial color, and upon being saturated with a liquid of a certain pH 330, the wick may change colors. Upon exhaustion of the liquid (for example, through evaporation), the wick may return to its original color thereby indicating exhaustion of the liquid.

In accordance with some embodiments of the present invention, the wick 300 may be comprised of a porous, self sustaining, three dimensional bonded fiber component, where one of the exposed polymeric components of the fiber has been reacted with certain pH sensitive dyes. When the liquid 330 (i.e., a fragrance solution) impregnates the wick 300 and flows via capillary forces to the top of the wick 300, the wick 300 may change color depending on pH conditions provided by the liquid 330. After the liquid is exhausted, the wick 300 may adopt a more neutral pH due to interaction with ambient environment, and may then assume the color of the neutral form of the pH sensitive dye 310. In accordance with some embodiments, the dye contained in the wick 300 may have a color change point at a pH of between 4 and 7.

The nature of the color change is illustrated in FIG. 3. At time t0, the wick 300 has just been inserted into the fragrance solution, and the wick 300 is still the color of the neutral form of the pH sensitive dye 310. At time t1 and later t2, the wick 300 has wicked the fragrance solution throughout the wick 300, thereby changing the color in the wick to the color indicated by the pH sensitive dye 320. At time t3, the fragrance solution 330 is exhausted, and the wick 300 returns to the color of the neutral form of the pH sensitive dye 310.

The wick may be comprised of bicomponent fibers with the sheath polymer being comprised of a polyamide. These wicks may have particular utility in that many pH sensitive dyes are in the class of dyes called acid dyes, and will react with polyamide surfaces. Additionally, fibers containing polymers which will react with pH sensitive cationic dyes may also be used. One category of polymers with this characteristic is polyesters modified with sulfonic acid moieties, so called “cat-dye” polyesters.

### EXAMPLE 1

In accordance with some embodiments of the present invention, a wick 300 is provided which is capable of accepting acid dyes and has the ability to undergo a color change based on changes in pH level. The wick may be comprised of melt blown, sheath/core bicomponent fibers, with the sheath comprised of a polyamide, such as nylon-6 and the core comprised of either a polyolefin, such as polypropylene, or a polyester, such as polyethylene terephthalate or polybutylene terephthalate. To color such wicks a pH sensitive dye (methyl Red) (0.005 g) was dissolved in a mixture of: isopropyl alcohol (4% by weight), water (92% by weight), Tween 20 (1% by weight) and 20% acetic acid (3% by weight). This solution had a pH of approximately 2.7. The wick 300 may be colored by dipping the wick into this solution at 60° C.

The liquid may be formulated from water (48% by weight), isopropyl alcohol (10% by weight), dipropylene glycol methyl ether (40% by weight) (to control evaporation rate), 20% acetic acid (to adjust pH) (1% by weight), and oil-based fragrance (1% by weight). The pH of this particular liquid solution is approximately 3.5. The formulation of the fragrance can be adjusted to the consumer's specific needs: other alcohols and glycol ethers in the different ratios can be used. When Methyl Red is used as the acid dye, the wick changes from red (when the wick is wet with the fragrance solution), to yellow (when the wick is dry and the fragrance solution has been exhausted).

Other acid dyes suitable to color wicks include, but are not limited to: P-xylenol blue; alizarin red S; thymol blue sodium salt; phloxine b; m-cresol purple; cresol red; bromocresol green; bromcresol purple; ethyl red; or methyl red.
ii. pH Sensitive Dye Visible in Wick

In the second manner, the liquid 330 itself may comprise dyestuff. The dyestuff in the liquid may be pH sensitive, and the liquid 330 may be of a particular pH. The particular pH of the liquid 330 may cause the dyestuff to assume a particular color, thereby causing the liquid to appear a certain color. While the liquid 300 may be dispensed from the system (via, for example, evaporation) the dyestuff may remain in the wick 300, and the wick 300 will take on the color of said dyestuff. Once the liquid 330 is exhausted from the system, the pH environment of the dyestuff remaining on the wick 300 may be different, causing the dyestuff—and accordingly the wick—to assume a second color. This second color indicates end-of-life in that the liquid is exhausted from the system.

### EXAMPLE 2

In accordance with some embodiment of the present invention, a water-based fragrance is provided that comprises a dye which is capable of changing color when the fragrance is exhausted. In accordance with one embodiment of the present invention, the water-based fragrance is formulated with 0.01-0.1% content of pH sensitive dye dissolved in a blend of oil fragrance, water, isopropyl alcohol and dipropylene glycol methyl ether (“DPGME”). Acetic acid may also be used to adjust the pH of the fragrance to the range of 1.5-4.5. The content of DPGME or other glycol ethers used in the water-based fragrance may be as high as 60% without harming the visibility of the color change. Acid dyes suitable for use in water-based fragrance include, but are not limited to: Eosin B, p-xylenol blue; alizarin red S; thymol blue sodium salt; phloxine b; m-cresol purple; cresol red; bromocresol green; bromcresol purple; ethyl red; or methyl red. When Eosin B is used as the acid dye, the wick changes from white (when the wick is wet with the fragrance solution), to pink (when the wick is dry and the fragrance solution has been exhausted).

It will be apparent to those skilled in the art that various modifications and variations can be made in the method, manufacture, configuration, and/or use of the present invention without departing from the scope or spirit of the invention.

What is claimed is:

1. A vapor emitting device comprising:
a container having a container interior;
a first liquid disposed in the container interior; and
a wick having a distal wick portion disposed in the container interior and a proximal wick portion, the wick being configured and positioned so as to maintain contact with the first liquid and to draw the first liquid into and through the distal wick portion toward the proximal wick portion, thereby making the first liquid available for evaporation when the proximal wick portion is exposed to air, the wick being further configured so that a change in a visible characteristic of the wick occurs upon exhaustion of the first liquid from the wick.

2. The vapor emitting device of claim 1, further comprising:
a second liquid disposed in the container interior; and
wherein the wick is configured and positioned so as to maintain contact with both the first liquid and the second liquid.

3. The vapor emitting device of claim 2, wherein the first liquid and second liquid are immiscible.

4. The vapor emitting device of claim 3, wherein the first liquid is organic based and the second liquid is aqueous based.

5. The vapor emitting device of claim 2, wherein the wick draws the first liquid into and through the distal wick portion toward the proximal wick portion and then draws the second liquid into and through the distal wick portion toward the proximal wick portion, thereby causing the change in the visible characteristic of the wick.

6. The vapor emitting device of claim 5, wherein the change in the visible characteristic of the wick is a color change.

7. The vapor emitting device of claim 2, wherein the wick draws the second liquid into and through the distal wick portion toward the proximal wick portion and then draws the first liquid into and through the distal wick portion toward the proximal wick portion, thereby causing the change in the visible characteristic of the wick.

8. The vapor emitting device of claim 7, wherein the change in the visible characteristic of the wick is a color change.

9. The vapor emitting device of claim 1, wherein the wick comprises any material which will absorb the target material.

10. The vapor emitting device of claim 1, wherein the wick comprises fibers.

11. The vapor emitting device of claim 10, wherein the fibers comprises a material selected from the group consisting of polyethylene (and copolymers thereof), polypropylene (and copolymers thereof), nylon-6, nylon-6,6, nylon 12, semicrystalline polyamides (and copolymers thereof), semicrystalline polyesters, including polybutylene terephthalate and polyethylene terephthalate and cellulose acetate fibers.

12. The vapor emitting device of claim 10, wherein the fibers are monocomponent fibers.

13. The vapor emitting device of claim 10, wherein the fibers are bicomponent fibers.

14. The vapor emitting device of claim 1, wherein the wick comprises a plurality of fiber types.

15. The vapor emitting device of claim 10, wherein at least a portion of the fibers have a surface material that comprises hydrophilic material.

16. The vapor emitting device of claim 10, wherein at least a portion of the fibers have a surface material that comprises 1-19% hydrophilic nylon.

17. The vapor emitting device of claim 10, wherein at least a portion of the fibers are sheath/core bicomponent fibers, wherein the sheath is a blend of nylon-6 and hydrophilic nylon, and the core is a material selected from the group consisting of a polyolefin, a polyester, a polyamide, or a semicrystalline thermoplastic.

18. The vapor emitting device of claim 1, wherein the first liquid has a specific pH, the wick is pH sensitive, and the change in the visible characteristic of the wick occurs upon exhaustion of the first liquid from the wick.

19. The vapor emitting device of claim 18, wherein the change in the visible characteristic of the wick is a color change.

20. The vapor emitting device of claim 1, wherein the first liquid has a specific pH, the first liquid further comprising a pH sensitive dye, and the change in the visible characteristic of the wick occurs upon exhaustion of the first liquid from the wick.

21. The vapor emitting device of claim 18, wherein the fibers of the wick comprises a pH sensitive dye and the first liquid has a specific pH.

22. The vapor emitting device of claim 1, wherein the wick is a three-dimensional, self-sustaining bonded fiber structure comprising a plurality of polymeric fibers bonded to each other at spaced apart contact points.

23. The vapor emitting device of claim 1, wherein the wick is an multi-component structure comprising a plurality of components, at least one of which is a three-dimensional, self-sustaining bonded fiber structure comprising a plurality of polymeric fibers bonded to each other at spaced apart contact points.

24. The vapor emitting device of claim 1, wherein the vapor is emitted is selected from the group consisting of air fresheners, insecticide emitters, insect repellant emitters, humidifier wicks, odor removal compounds, and other functional liquid-to-vapor distribution devices.
